(19) United States
(12) Patent Application Publication
(10) Pub. No.: US 2006/0177519 A1
(43) Pub. Date: Aug. 10, 2006

(54) Chemotherapeutic agents for the control of plant and animal diseases

(76) Inventors: Will Hugh Hartfeldt, Edina, MN (US); Joleen Ann Perkins, Golden Valley, MN (US); Virginia Marlene Wrobel, Inver Grove Heights, MN (US); Lonnie Paul Kensek, Andover, MN (US); Mary Beth Kensek, Andover, MN (US)

Correspondence Address: OFFICES OF CRAIG GREGERSEN, P.O. BOX 386353, 10032 QUEBEC AVENUE SOUTH, BLOOMINGTON, MN, 55438, US

(21) Appl. No.: 11/313,009

(22) Filed: Dec. 20, 2005

Related U.S. Application Data
(63) Continuation of application No. 60/637,881, filed on Dec. 21, 2004.

(51) Int. Cl. A01N 59/20; A01N 55/02

(52) U.S. Cl. 424/637; 514/499

(57) ABSTRACT

A chemotherapeutic composition for the control of plant diseases caused by viral, bacterial, and fungal organisms is disclosed. The composition is composed essentially of a tannate complex of cupric ammonium formate in aqueous solution combined with a an amount of a surfactant sufficient to prevent separation of ammonium tannate. The preparation and use of the composition are disclosed.

This application claims priority from U.S. Provisional Patent Application Ser. No. 60/637,881 filed Dec. 21, 2004, and is related to co-pending U.S. patent application Ser. No. ______, filed on even date herewith.

### FIELD OF THE INVENTION

This invention relates broadly to the field of chemotherapeutic control of plant and animal diseases caused by certain organisms and particularly to chemotherapeutic agents for controlling bacterial and fungal plant diseases.

### BACKGROUND OF THE INVENTION

### The Prior Art

The present assignee, Phyton Corp. of Edina, Minn., is also the owner of the following United States patents: U.S. Pat. No. 4,544,666 to Thirumalachar et al.; U.S. Pat. No. 4,673,687 to Thirumalachar et al.; and U.S. Pat. No. 6,646,000 to Hartfeldt. The present assignee is also the owner of published U.S. Patent Application No. 2004/0138144 to Hartfeldt. These patents and the published patent application are incorporated by reference herein in their entirety.

Broadly speaking, these patents and the published patent application discuss the formulations, methods of formulating, and uses of chemotherapeutic agents designated therein as KT-198 and KT-19827, particularly their beneficial uses relating to plants. KT-19827 is sold commercially under the trade name Phyton-27™ by the present assignee, Phyton Corp.

More specifically, these patents and the published application describe the chemotherapeutic control of plant diseases caused by Phytoplasma sp. (a group of organisms once called mycoplasma-like organisms or MLO), Spiroplasma sp., and Xylella sp. (a group of organisms once called rickettsia-like organisms or RLO) with the chemotherapeutic agent designated KT-198.

Phytoplasma sp. has been associated with several hundred important plant diseases worldwide, including such diseases as stolbur, aster yellows, apple proliferation, coconut lethal yellowing, pigeonpea witches'-broom, X-disease, rice yellow dwarf, elm yellows, ash yellows, sunnhemp phyllody, loofah witches'-broom, clover proliferation, peanut witches'-broom, Australian grapevine yellows, Italian bindweed stolbur, buckthorn witches'-broom, Spartium witches'-broom, Italian alfalfa witches'-broom, Cirsium phyllody, Bermuda grass white leaf, Tanzanian lethal decline, Brazilian hibiscus witches'-broom, Korean chestnut witches'-broom, almond lethal disease, jujube witches'-broom, pear decline, European stone fruit yellows, allocasuarina yellows, etc.

Spiroplasma sp. has been associated with such diseases as citrus stubborn, corn stunt, etc.

Xylella sp. has been associated with such diseases as phony peach, Pierce's diseases of grapes, citrus greening and die-back, grassy shoot of sugar cane, etc.

Another group of diseases for which KT-198 was developed is against some of the legume viruses that are seed-borne.

Additionally these patents describe the chemotherapeutic control of plant diseases where the causal organisms are plant pathogenic fungi and bacteria with KT-19827.

In Phytoplasma sp., Spiroplasma sp., and Xylella sp. induced diseases, prior to the development of KT-198 and KT-19827, the only means of control was treating the plants by injections or spray schedules with tetracyclines. These treatments brought about temporary regression of the symptoms, which, however, reappeared after some time.

There are very few antiviral chemotherapeutants known for control of animal viruses, and fewer still for plant viruses. Among a few of the clinically used chemotherapeutants against DNA animal viruses, mention may be made of idoxuredine, arabinofuranosylcytosine, arabino-furanosyladenine, methisazone and 6-azauredine. Some of the chemotherapeutants against oncogenic viruses include cyclohexamide, noformacin, ribavirin, dimethylbenzylrifampicin, etc.

Among compounds used as fungicides, bactericides and anti-fouling agents (including killing of algae), copper compounds are well known and numerous patents have been granted for their use. These copper compounds can be grouped under two headings:
(1) WATER SOLUBLE COPPER COMPOUNDS—All soluble copper compounds are highly toxic to the living plants and are used only on dead materials such as cellulose fibers, as components of wood preservatives, anti-fouling agents where the intention is killing the polluting agent, like algae in ponds, etc. When used on living plant tissue, they show high phyto-toxicity, burn and kill the plants. The soluble copper compounds previously used include (a) cupric sulfate, (b) cupric acetate, (c) cupric chloride and cupric chlorate, (d) cupric formate, also called Tubercuprose, (e) cupric hexafluorosilicate, (f) cupric nitrate, (g) cupric chromate (used in preventing growth of fungi and bacteria infesting cellulose fibers), and (h) cupric ammonium complex.
(2) WATER INSOLUBLE COPPER COMPOUNDS—All copper fungicides used at present are water insoluble complexes, and form deposits on the treated parts as colloidal layers. When the fungus spore germinates on the surface, soluble copper is released and the fungus is killed. In brief, none of the presently existing fungicides is absorbed and translocated within the plant tissue without killing the host cells as well as killing the fungal or bacterial pathogen.

KT-19827 is useful in the control of plant diseases caused by pathogenic fungi and bacteria. KT-198 is useful in control of plant diseases caused by pathogenic Phytoplasma sp., Spiroplasma sp., Xylella sp. and plant viruses.

KT-19827 and KT-198 also have the ability to pass through cell walls and kill certain arthropods; arachnids, such as mites; insects, such as aphids and whiteflies; certain mollusks, such as slugs; and certain other animals such as nematodes and similar pests which afflict the foliage, stems, roots, blossoms and seeds of plants. This property enables KT-19827 and KT-198 to be used by application to plants or to the soil around plants to control the numbers of these plant pests. It has also been discovered that KT-19827 and KT-198 can be of significant nutritive value to the plants treated.

The prior art discloses the ability of KT-19827 and KT-198 to quickly translocate from the injection site in a tree through the entire tree from the roots to the crown leaves and the ability to disperse in all directions not limited to elongated translocational cells composing the vascular system. This ability may be utilized to carry other substances, such as nutrients, admixed with KT-19827 or KT-198 to distribute the added substance from the application site throughout a treated plant, shrub or tree, for delivery to the points of use via the plant's own internal transport system. The ability of KT-19827 and KT-198 to penetrate plant cell walls and move among cells in multiple directions may be utilized to introduce substances such as nutrients to the plant, as by spraying or dipping, at standard rates and intervals prescribed by the US EPA label for pesticidal efficiency without doing plant damage.

These agents may also be used for disinfection of inanimate surfaces proximate to plants or humans or animals, a use which derives from the discovered high level of free copper ions, Cue. High ionic copper levels equate to greater efficacy against bacterial and other pathogens. The low total copper as metallic needed for efficacy against bacterial and other pathogens assures that it can be obtained without copper damage to plants proximate to the disinfected site.

The ability of KT-19827 and KT-198 to pass through cell walls and kill certain pests enumerated above also enables KT-19827 and KT-198 to be used to control other pests found in and around structures for habitation by humans and animals; control of animal pests such as bird lice, and control of human pests such as mites and head lice, fungal infections of the feet, microbial infections of cartilage and other sternum locales exposed to hospital infections during surgery which do not respond, due to low or no blood-circulation, to standard antibiotics ingested or given intravenously.

The prior art further discloses the following: a) the use of the referenced chemotherapeutic agents to increase plant crop yield by nourishing a plant by introducing to the plant a dilute aqueous solution of KT-19827 or KT-198 alone or supplemented with dissolved plant nutrients applied as foliar sprays, soil drench or vascular injection; b) a method of improving plant health by applying KT-19827 or KT-198 to prevent frost damage, to induce desiccation of partially frost damaged tissue, and to stimulate adjoining viable tissue; c) a method of improving plant health by stimulating the plant's own health system, benefits sometimes called systemic activated resistance, (SAR) to disease, achieved by treatment of plants with a dilute aqueous solution of KT-19827 or KT-198; d) a method of improving control of plant diseases and pests through synergistic improvements achieved by combining KT-19827 or KT-198 with other commercially available pesticidal products; e) a method of disinfection of inanimate surfaces proximate to plants by treatment with unexpectedly dilute aqueous solutions of KT-19827 or KT-198; and f) a method of controlling arachnids, insects, bacterial, fungal, slugs, nematodes, Phytoplasma sp., Spiroplasma sp., and Xylella sp. induced diseases, and viral pests of animals and humans.

As disclosed in the referenced prior art, KT-198 is a tannate complex of picro ammonium formate combined with a minor amount of a surfactant sufficient to prevent formation of ammonium picrates while KT-19827 is a tannate complex of picro cupric ammonium formate in aqueous solution combined with a minor amount of a surfactant sufficient to prevent formation of ammonium picrate.

As recited in the '666 patent, picric acid was believed to be an essential ingredient in the formation of the agents KT-198 and KT-19827. Thus, for example, the '666 patent states:
The avidity of picric acid to form complexes with copper ammoniates is well known. Joshi and Bhargava (Journal of Indian Chemical Society 40: 19-22, 1963; Chemical Abstracts, 58: 13408 d, 1963) showed that when picric acid is added to a cupric ammoniacal solution, an olive green precipitate is formed which by spectrophotometric study showed that the picric acid copper ammoniate complex had one part of Cu(NH₃)₄⁺⁺ and 2 parts of picric acid. N. P. Agafoshin (Chemical Abstracts 32: 72, 1938) reported that complex compounds of picric acid with copper ammoniates are formed when aqueous solutions of picric acid are added to NH₄OH solution of Cu (OH)₂. A precipitate of the complex is formed with the formula [(C₆H₂ (NO₂)₂O)]₂—(CuNH₂)₄.
The role of picric acid is as a mordant on the walls of the pathogens which then in the case of KT-19827 permits greater penetration. Penetration of the copper complex through the pathogen walls and the plant cell walls is enhanced by it being complexed with the ammonium formate into a more soluble ionizable form.
   U.S. Pat. No. 4,544,666, col. 5, II. 6-20; col. 6, II. 53-58.

Picric acid was thus believed to facilitate the systemic properties of KT-198 and KT-19827 as well as to provide nitrogen, thus providing KT-198 and KT-19827 with a fertilizing function.

The use of picric acid, or 2,4,6-trinitropheno (C₆H₂(NO₂)₃OH) in the formulation of KT-198 and KT-19827 has always proved problematic. First and foremost, picric acid is explosive. Historically, picric acid was used as a military explosive until replaced by TNT. Its principal use now as an explosive is as a booster to detonate less sensitive explosives, such as TNT. In its dry powder form, picric acid is extremely sensitive to shock and friction and its transport is forbidden in the United States. To reduce the likelihood of an explosion, it is recommended that picric acid be stored under water.

Not only does its explosive tendencies make picric acid difficult to handle and difficult to transport, but its capability to be used as an explosive has made its acquisition and use a focus of government interest, particularly since the attacks on the World Trade Center in New York City on Sep. 11, 2001.

In addition, because of its health and safety hazards, the use of picric acid is subject to occupational health regulations and environmental regulations regarding safe and non-polluting use and disposal.

Because of all of the foregoing, picric acid has become increasingly difficult to obtain, with no domestic suppliers currently known to be available to the inventors.

Thus, even though picric acid was understood by the teachings of the prior art to be necessary to the formulation and the efficacy of KT-198 and KT-19827 as chemotherapeutic agents capable of providing the benefits set forth in the referenced art, there existed a long-felt desire to find a chemotherapeutic agent formulation that provided those same benefits while reducing or eliminating the use of picric acid. The present inventors discovered that picric acid could be completely eliminated from the KT-19827 formulation yet still provide the same systemic chemotherapeutic benefits, but without the significant fertilizing functions of KT-19827. This formulation is designated hereafter as Phyton-016 and its variation as Phyton-016-B.

Further research has revealed another chemotherapuetic formulation designated as STBX-304, also made without picric acid, that provides the systemic chemotherapeutic benefits similar to that described above and that buffers the effects of excess alkalinity or acidity of native waters, as well as provides the fertilizer functions originally provided by the picric acid in KT-198.

While testing of this new chemotherapeutic agent is ongoing, it is believed that these new chemotherapeutic agents are useful in the control of the following types of diseases and similar plant diseases as well as others specifically mentioned herein:
(1) Internally and externally seed-borne fungal and bacterial diseases of plants.
(2) Downy mildew and powdery mildews of plants caused by fungi.
(3) Root rots and wilt diseases of plants where the organisms are soil-borne, and where many of the conventional fungicides cannot be used.
(4) Systemic-infected trees where the fungus is in the vascular tissues and only those systemic fungicides which when injected are translocated inside the vascular strands can be used. As examples, the oak wilt disease caused by the fungus Ceratocystis fagacearum and the Dutch elm disease caused by the fungus Ophiostoma ulmi (formerly known as Ceratocystis ulmi).
(5) A large number of systemic plant bacterial diseases incited by species of the genus Xanthomonas, Pseudomonas, Erwinia and Corynebacterium, which up to the present were controlled chiefly by the use of antibiotics such as streptomycin and tetracyclines or their combination.

### BRIEF DESCRIPTION OF THE INVENTION

Broadly stated, the fungicide and bactericide designated Phyton-016 is a tannate complex of cupric ammonium formate in aqueous solution combined with a an amount of a surfactant sufficient to prevent separation of ammonium tannate. The complex is produced by reacting a water soluble cupric salt, such as cupric sulfate, with ammonium formate, and combining that with tannic acid in aqueous solution containing a minor amount of a surfactant sufficient to prevent separating out of the tannate complex. In one embodiment of this chemotherapeutic agent, one mole of a water soluble cupric salt, such as cupric sulfate, is reacted with a stoichiometric equivalent of 2 moles of ammonium formate, or with a stoichiometric excess of 15 to 45 percent by weight of ammonium formate (2.3 to 2.9 moles). For each 100 parts by dry weight of cupric ammonium formate, surfactant is added in amount between about 2 to 15 parts by dry weight and tannic acid is added in amount between about 0.5 to 4.0 parts by weight. Water is added to the desired concentration. The complex is produced as a concentrate and may be diluted to various levels depending on the organism and plant treated.

In another embodiment of Phyton-016, hereinafter designated as Phyton-016-B, a new chemotherapeutic agent comprises a tannate complex of cupric ammonium formate in aqueous solution combined with an amount of a surfactant sufficient to prevent separation of ammonium tannate. Phyton-016-B can be produced by mixing about 1 percent by weight of the final product of tannic acid with about 48 percent by weight of deionized water and mixed. Ammonium formate in the amount of about 12-13 percent by weight can be mixed therein with about 21 to 22 percent by weight of copper sulfate pentahydrate. Surfactants, such as sodium lauryl sulfate and decyl glucoside, can be added for the purposes described above to complete the formulation.

The fungicide and bactericide designated STBX-304 is a tannate complex of cupric ammonium formate in an aqueous solution combined with a surfactant to prevent precipitation and a buffer to enable its use in native waters. In one embodiment of this chemotherapeutic agent, one mole of a water soluble cupric salt, such as cupric sulfate, is reacted with a stoichiometric equivalent of 2 moles of ammonium formate, or with a stoichiometric excess of 15 to 45 percent by weight of ammonium formate (2.3 to 2.9 moles). For each 100 parts by dry weight of cupric ammonium formate formed surfactant is added in amount between 2 to 15 parts by dry weight, tannic acid is added in amount between 0.5 to 4.0 parts by weight, and Triethanolamine is then added in amount between 100 to 120 parts by weight. Water is added to the desired concentration. The complex is produced as a concentrate and may be diluted to various levels depending on the organism and plant treated.

The present invention, as well as its various features and advantages, will become evident to those skilled in the art when the following description of the invention is read in conjunction with the accompanying descriptions of use.

### DETAILED DESCRIPTION OF THE INVENTION

A. Production of Phyton-016

The chemotherapeutic agent Phyton-016 is a tannate complex of cupric ammonium formate in aqueous solution combined with a minor amount of a surfactant sufficient to prevent separating out of the tannate complex. Phyton-016 is a soluble complex and is also relatively non-toxic to animals and plants at doses used to control various bacterial, fungal, and viral plant diseases.

Cupric ammonium formate CuNH₄ (HCOO)₂ is produced when one mole of water soulble cupric salt, such as cupric sulfate, is reacted with 2 moles of ammonium formate in aqueous medium. Tannic acid addition to this results in formation of the tannate complex, which is water-soluble gradually dissociating into water insoluble cupric tannate. It has been pointed out by studies of A. W. Davidson and Vernon Holm (Journal of American Chemical Society 53:1350-1357, 1931) that the solubility of cupric ammonium formate increases with excess addition of ammonium formate up to 43.75 mole percent. There is no solid phase separating out, and on slight warming a deep violet bluish solution is formed. A ternary system NH₄ CHO₂—Cu(CHO₂)₂—HCHO₂ is formed.

The details for the production of an embodiment of Phyton-016 are described below.

9.0 grams of ammonium formate (molecular weight 63) is dissolved in 56.1 g of water containing 1.0 grams of tannic acid and heated to 35° C. 21.4 grams of cupric sulfate pentahydrate (molecular weight 249.68) is added, and warmed on a water bath at 65° C. until a clear deep blue solution is formed. 5.2 grams of 28% active sodium lauryl sulfate and 7.3 grams of 55% active sodium dodceylbenzene sulfonate are added and the mixture agitated until all the surfactants are dissolved. A deep greenish-blue solution is formed.

In this embodiment of Phyton-016, the ingredients form the following percentages by weight of the final product.

| Ingredient | Percentage |
|---|---|
| Water | 56.1 |
| Tannic Acid | 1.0 |
| Ammonium Formate | 9.0 |
| Copper Sulfate Pentahydrate | 21.4 |
| Sodium Lauryl Sulfate (28% active) | 5.2 |
| Sodium Docecylbenzenesulfonate (55% active) | 7.3 |

Variations of Phyton-016 may be made in any of the following ranges:

| Ingredient | Range |
|---|---|
| Water | 10-90% |
| Tannic Acid | .2-2% |
| Ammonium Formate | 2-18% |
| Copper Sulfate Pentahydrate | .01-45% |
| Sodium Lauryl Sulfate (28% active) | 1-10% |
| Sodium Docecylbenzenesulfonate (55% active) | 1-14% |

The presence of a surfactant in Phyton-016 serves several purposes. The surfactant acts as a spreader when the chemotherapeutic agent is sprayed. It also enhances the diffusion of the agent into remote pockets within the plant when plant injections with the agent are made. Other surfactants may be used in Phyton-016, such as other alkali metal alkyl sulfates. The effect of tannic acid in Phyton-016 is to antidote the phytotoxicity of copper.

B. Chemotherapeutic Use of Phyton-016

Testing has been ongoing on the chemotherapeutic effects of Phyton-016, results shown below, which has shown that Phyton-016 will provide the same benefits as KT-19827 in controlling the following bacterial and fungal plant diseases. Actual test reports produced by independent entities pursuant to contracts with the present assignee of the use of the compositions disclosed and claimed herein are set forth in the appendices below.

Bacterial Plant Diseases

Crown Gall

Erwinia

Pseudomonas

Xanthomonas

Fungal Plant Diseases

Altemaria

Anthracnose

Black spot

Botrytis

Cedar Apple Rust

Cercospora

Colletotrichum

Cylindrocladium

Diplodia

Dothistroma

Downy Mildew

Entomosporium

Fireblight

Phomopsis

Phytophthora

Powdery Mildew

Rhizoctonia

Rust

Scab

Verticillium

Volutella

C. Production of 016-B

The complex Phyton-016-B differs principally from the complex Phyton-016 in the surfactants used in the formulation. Thus, Phyton-016-B utilizes sodium lauryl sulfate and decyl glucoside as surfactants.

Phyton-016-B can be produced, for example, by adding an amount in the above noted range of tannic acid with noted range of water and then mixing and heating to 35° C. until dissolved. Ammonium formate in the above range is added and warmed on a water bath at 65° C. An amount of copper sodium pentahydrate is added in the above noted range until completely in solution while maintaining temperature. Finally, the surfactants sodium lauryl sulfate and decyl glucoside are added. The percent by weight of sodium lauryl sulfate can vary between about 1 percent and about 10 percent and decyl glucoside can vary between about 1 percent and about 25 percent.

D. Production of STBX-304

The chemotherapeutic, STBX-304, is a buffered tannate complex of cupric ammonium formate in aqueous solution combined with a minor amount of a surfactant sufficient to prevent separating out of the tannate complex. STBX-304 is a soluble complex and is also relatively non-toxic to animals and plants at doses used to control various bacterial, fungal, and viral plant diseases.

Cupric ammonium formate CuNH₄ (HCOO)₂ is produced when one mole of water soluble cupric salt, such as cupric sulfate, is reacted with 2 moles of ammonium formate in aqueous medium. Tannic acid addition to this results in formation of the tannate complex, which is water-soluble gradually dissociating into water insoluble cupric tannate. It has been pointed out by studies of A. W. Davidson and Vernon Holm (Journal of American Chemical Society 53:1350-1357, 1931) that the solubility of cupric ammonium formate increases with excess addition of ammonium formate up to 43.75 mole percent. There is no solid phase separating out, and on slight warming a deep violet bluish solution is formed. A ternary system NH₄ CHO₂—Cu(CHO₂)₂—HCHO₂ is formed.

The details for the production of an embodiment of STBX-304 are described below.

9.0 grams of ammonium formate (M.W. 63) is dissolved in 31.6 g of water containing 0.7 grams of tannic acid and heated to 35° C. 21.4 grams of cupric sulfate pentahydrate (M.W. 249.68) is added, and warmed on a water bath at 65° C. until a clear deep blue solution is formed. 5.2 grams of 28% active sodium lauryl sulfate and 7.3 grams of 55% active sodium dodceylbenzene sulfonate are added and the mixture agitated until all the surfactants are dissolved. A deep greenish-blue solution is formed. 24.8 grams of 99.0% active triethanolamine are added to the solution, or the amount required to reach a pH of 6.2-6.4.

The presence of a surfactant in STBX-304 serves several purposes. The surfactant acts as a spreader when the chemotherapeutic agent is sprayed. Other surfactants may be used in STBX-304, such as other alkali metal alkyl sulfates. The effect of tannic acid in STBX-304 is to antidote the phytotoxicity of copper. Triethanolamine functions to adjust the pH of the resulting concentrate to near neutrality thereby reducing its phytotoxic properties, and in combination with Tannic Acid/Cupric Ammonium Formate forms a buffering complex that controls the pH of the resulting use dilution solutions. This enables the concentrate to be diluted with native waters of a wide pH range. Additionally, Triethanolamine furnishes a high level of Nitrogen, which on decomposition is released as a fertilizing constituent.

In one embodiment of STBX-304, the ingredients form the following percentages by weight of the final product.

| Ingredient | Percentage |
|---|---|
| Water | 31.6 |
| Tannic Acid | 0.7 |
| Ammonium Formate | 9.0 |
| Copper Sulfate Pentahydrate | 21.4 |
| Sodium Lauryl Sulfate (28% active) | 5.2 |
| Sodium Docecylbenzenesulfonate (55% active) | 7.3 |
| (a) Triethanolamine (99% active) | 24.8 |

Variations of STBX-304 may be made in any of the following ranges:

| Ingredient | Range |
|---|---|
| Water | 10-90% |
| Tannic Acid | .2-2% |
| Ammonium Formate | 2-18% |
| Copper Sulfate Pentahydrate | .01-45% |
| Sodium Lauryl Sulfate (28% active) | 1-10% |
| Sodium Docecylbenzenesulfonate (55% active) | 1-14% |
| Triethanolamine (99% active) | 5-45% |

E. Chemotherapeutic Use of STBX-304

Testing results, shown below have shown that STBX-304 will provide the same benefits as KT-19827 in controlling the following fungal and bacterial plant diseases:

Bacterial

Crown Gall

Erwinia

Pseudomonas

Xanthomonas

Fungal

Alternaria

Anthracnose

Black spot

Botrytis

Cedar Apple Rust

Cercospora

Colletotrichum

Cylindrocladium

Diplodia

Dothistroma

Downy Mildew

Entomosporium

Fireblight

Phomopsis

Phytophthora

Powdery Mildew

Rhizoctonia

Rust

Scab

Verticillium

Volutella

Actual test reports produced by independent entities pursuant to contracts with the present assignee of the use of the compositions disclosed and claimed herein are set forth below. These reports have been modified by reformatting and making the terminology of the agents consistent throughout.

### Test Reports

### Evaluation of Products for Control of Bacterial Spot of Peach During the Cover Sprays

### University of Georgia

Start Date: 1 Mar. 2004

Completion Date: 31 Aug. 2004

Methodology

Tests were established in mature O'Henry peach orchards in South Carolina (Edgefield County). In the South Carolina trial, routine early-season (dormant through bloom) copper sprays were omitted to allow build-up of inoculum for the test. Single-tree plots, replicated five times and surrounded by untreated buffer trees, were demarked in the orchards. Starting at late petal fall and using a motorized Solo mist blower, treatments (Tables 2) were applied to the plots in a water volume of ˜1 gal/tree at 8 to 18-day intervals until ˜1 month before harvest. Routine fungicide and insecticide sprays were applied uniformly by the grower collaborator.

Following the first spray at late petal fall, copper damage was noted on the foliage. Therefore, a phytotoxicity assessment was made at each site 10 days after the first application in each copper treatment plot (percent leaf area damaged on 25 arbitrarily selected leaves). At the South Carolina site, fruit disease incidence was determined on 12 July using a sample of 100 fruit per tree, and an estimate of disease severity was obtained by measuring the depth of the deepest bacterial spot lesion per fruit in a sample of 20 symptomatic fruit per tree harvested on 27 July.

Results

Characteristic copper phytotoxicity was observed on the foliage following application of the petal fall spray (which was made at a rate of 8.0 oz/A metallic Cu) but not after subsequent sprays (applied at a lower rate of 0.5 oz/A metallic Cu). Phytotoxicity symptoms were noted for 016. Although damage on some leaves was significant, symptoms did not increase over time, nor were they associated with increased levels of defoliation. Trees had outgrown the phytotoxicity symptoms by mid-summer. In the South Carolina trial, bactericide treatments significantly affected fruit disease incidence (P=0.0091) and lesion depth (P=0.0365). Average disease incidence in the untreated control was moderate at 21.2% (Table 2). 016 was shown to have numerically a low disease incidence values.

Conclusions

Copper products can be applied effectively and safely during the cover sprays. Although the first spray at the higher rate of 8.0 oz/A metallic Cu did induce noticeable phytotoxicity on the foliage, trees were able to outgrow the damage by mid-summer without significant defoliation.

TABLE
Cover spray bactericide treatments and their
associated phytotoxicity and bacterial spot levels
on O'Henry peach in the South Carolina trial

| | Cu | | Average lesion |
|---|---|---|---|
| | phytotoxicity, | Fruit disease | depth on |
| Treatment | % leaf area | incidence, % | infected fruit, mm |
| and rate/A^{a} | affected (14 Apr)^{b} | (12 Jul)^{b} | (27 Jul)^{b} |
| Untreated control | . . .^{c} | 21.20 ± 2.5 a | 0.88 ± 0.02 ab |
| 016 0.5 oz | 31.6 ± 1.8 A | 5.40 ± 1.5 c | 0.72 ± 0.09 ab |
| metallic Cu^{d} | | | |

^{a}Applications were made on 2, 14, and 22 Apr; 5 and 14 May; 1, 14, and 23 Jun; and 5 Jul.
^{b}Values are means and standard errors based on five replicate single-tree plots per treatment.
Means within each column followed by the same letters are not significantly different according to Fisher's protected LSD test.
^{c}Not determined.
^{d}The first application at late petal fall was made at a rate of 8.0 oz/A metallic Cu.

### Evaluation of 016 for Control of Gray Mold in Greenhouse Tomatoes

### Mississippi State University Truck Crops Experiment Station

Procedures

All experiments were conducted at the Mississippi State University Truck Crops Experiment Station located in Crystal Springs, Miss. The experiment allowed a maximum of eight treatments with three replications in a completely randomized design. Seeds of the variety ‘Trust’ were germinated in a commercial potting mix in cell pack trays placed on a bench in a propagation house designed for this purpose. After six weeks of growth three seedlings were transplanted into each pine bark bag in the greenhouse in mid-October, 2002. Greenhouse temperatures were set to maintain a low temperature of 68 F and a high temperature of 87 F.

The Botrytis cinerea isolate used in this study was collected from a greenhouse tomato sample exhibiting symptoms of gray mold. Inoculum for use in this study was produced on half strength potato dextrose agar. Petri plates with Botrytis were incubated on the laboratory bench at approximately 20 C with a 12 hr photoperiod for the first 7 days, and then placed in the dark at 20 C for an additional 7 days to stimulate sporulation.

After transplanting in the greenhouse, plants were grown for about four weeks to the 4-5 flower clusters per plant stage. Two types of inoculation procedures were employed in attempts to initiate severe disease development. Petri plates with conidia served as the inoculum source. Initially, plates with the lids removed were placed under tomato plants in the center of each row (24 plates total). Inoculation consisted of dispersal of conidia by air currents and splashing water. Plants at this stage of growth were tied to trellising and some lower leaves had been pruned resulting in wounds in the stems, providing entry sites for germinating conidia. Later during the growing season, petri plates with conidia were flooded with a Tween 20™ solution and conidia scraped into a beaker with a bent glass rod. This conidial suspension was diluted with distilled water to a rate equivalent to 32 ounces of mixture per treatment (conidial concentration was not determined but a microscopic examination estimated at least 1×10³ spores/ml). A third inoculation was made in the same manner. Inoculations were made on Jan. 24, Feb. 2, and Mar. 25, 2003.

Treatments were implemented when plants were established in the greenhouse production system and had at least 4-5 flower clusters. The following treatments were employed:
1) Inoculated control
2) Inoculated, treated with 016 @ 20 oz product/100 gal

All fungicides were mixed and applied in distilled water. There was no non-inoculated control treatment.

Fungicide applications were made beginning on Jan. 23, 2003, one day prior to inoculum applications. Fungicide applications were also made on Feb. 7, 2003 and Mar. 18, 2003. Fungicides were applied to just before runoff. Inoculated control treatment received distilled water only.

Data Collected

Data collection included percentage of plant tissue affected by gray mold and marketable yield per plant. Harvests usually were twice per week during peak production with the first harvest in mid-February, 2003 and the last on May 1, 2003. Marketable yield per plant was determined at each harvest. Disease severity was determined using a visual rating system to indicate percentage of plant tissue showing gray mold disease symptoms and ranged from 0=no gray mold symptoms to 100=entire plant showing symptoms. Disease severity ratings were made on Apr. 14 and 29, and May 29, 2003.

Statistical Analysis

All data were subjected to analysis of variance using SAS version 8.01 for PC. Data were analyzed using a completely randomized design for eight treatments with three replications. When there were significant F values for a particular factor, means for those factors were separated using Fisher's Protected Least Significant Difference Test (FPLSD) at a probability level of P<0.05.

Results and Discussion

Results of statistical analyses for the disease severity ratings and marketable yield per plant are presented in Table 1. An experimental product, 016 resulted in a lowest disease severity rating.

Yield data appeared to closely relate to the disease severity ratings (Table 1). 016 resulted in significantly greater marketable yield per plant than the control. Yield ranged from 9.6 lb/plant for the control to 11.8 lb/plant for 016. This difference is approximately 2.0 lb/plant, which would be economically significant with 300 plants in one 24×96 ft greenhouse.

Ghost spot symptoms were observed on mature green fruit about mid-March and before significant foliar symptoms began to appear. Observations of fruit symptoms from the treatments suggest that no fungicide totally prevented ghost spots. Fifteen mature red fruit observed at random from each treatment x replicate combination, had anywhere from just over 8-27% incidence of ghost spots. This observation was made about 20 days after the last fungicide application, thus all fruit should have been subjected to the fungicides. However, there is no clear correlation between fungicide treatments and the inoculated control because the control had values lower than four of the fungicides tested (this data has not been statistically analyzed).

Whitefly populations did slowly increase within the greenhouse during the later period of the growing season, which may have contributed to decline in the tomatoes resulting in increased gray mold infection.

TABLE 1
Botrytis disease severity ratings and marketable yield of ‘Trust’
tomatoes treated with fungicides at Crystal Springs, MS, 2003.

| | Disease | Marketable Yield^{z} |
|---|---|---|
| | Rating^{y} | Per Plant |
| Fungicide | (0-100%) | (lb) |
| 016 | 15.0 a | 11.8 a |
| Control | 53.3 c | 9.6 c |
| FPLSD (0.05) | 12.2 | 1.3 |
| CV (%) | 22.0 | 6.7 |

^{y}Plants within a row were visually rated for percentage of plant tissues affected by gray mold infection. 0 = no gray mold symptoms and 100 = whole plant showing symptoms.
^{z}Adding the weight of saleable tomatoes across all harvest dates and conducting analysis on the total weight values determined marketable yield per plant.

### Evaluation of Fungicides for Control of Gray Mold in Greenhouse Tomatoes Procedures

All experiments were conducted at the Mississippi State University Truck Crops Experiment Station located in Crystal Springs, Miss. The experiment allowed a maximum of six treatments with four replications in a randomized complete block design. Seeds of the variety ‘Trust’ were germinated in a commercial potting mix. After six weeks of growth two seedlings were transplanted into each perlite bag in the greenhouse in mid-October, 2003.

The Botrytis cinerea isolate used in this study was collected from a greenhouse tomato sample exhibiting symptoms of gray mold. Inoculum was produced on half strength potato dextrose agar. Petri plates with Botrytis were incubated at approximately 20 C with a 12 hr photoperiod for the first 7 days, and then placed in the dark at 20 C for 7 days to stimulate sporulation.

After transplanting in the greenhouse, plants were grown for about four weeks to the 4-5 flower clusters per plant stage. Three types of inoculation procedures were employed in attempts to initiate severe disease development. Petri plates with conidia of Botrytis were flooded with a Tween 20™ solution and conidia scraped into a beaker with a bent glass rod. This conidial suspension was diluted with distilled water to a rate equivalent to 48 ounces of mixture per treatment (conidial concentration was not determined but a microscopic examination estimated at least 1×10³ spores/ml). Plants were tied to trellising and some lower leaves had been pruned resulting in wounds in the stems, providing entry sites for germinating conidia. A second method of inoculation employed leaves infected with Botrytis, which were placed within the canopy of plants in the center of each plot. The third inoculation method used tomato stems infected with Botrytis which were laid at the soil line in the center of each plot. Inoculations were made on Feb. 3, 9 and Mar. 16, 2004.

Treatments were implemented when plants were established in the greenhouse production system and had at least 4-5 flower clusters. The following treatments were employed:
3) Inoculated, treated with 016 @ 20 oz product/100 gal

016 was mixed and applied in distilled water, and application rates were calculated on a per acre basis as suggested by Phyton Corp. There was no non-inoculated control treatment. It would be unlikely that gray mold infection can be prevented in one treatment placed randomly within inoculated plants.

Fungicide applications were made beginning on Jan. 30, 2004, four days prior to inoculum applications. Fungicide applications were also made on Feb. 13, 2004 and Mar. 1, 2004. Fungicides were applied to just before runoff. Inoculated control treatment received distilled water only.

### Data Collected

Data collection included percentage of plant tissue affected by gray mold and marketable and cull fruit yield per plot. Harvests usually were twice per week during peak production with the first harvest in mid-February, 2004 and the last May, 2004. Marketable yield per plot was determined at each harvest. Cull tomato fruit yield was also determined. Disease severity was determined using a visual rating system to indicate percentage of plant tissue showing gray mold disease symptoms and ranged from 0=no gray mold symptoms to 100=entire plant showing symptoms. Disease severity ratings were made on Mar. 30, Apr. 6, 20, 29 and May 5, 2004. Disease development occurred late in the season, thus only the last disease rating is reported here.

Powdery Mildew was observed in some plots about mid-March. Disease severity ratings were made on this potentially destructive greenhouse tomato disease as well.

### Statistical Analysis

All data were subjected to analysis of variance using SAS version 8.01 for PC. Data were analyzed using a randomized complete block design for six treatments with four replications. When there were significant F values for a particular factor, means for those factors were separated using Fisher's Protected Least Significant Difference Test (FPLSD) at a probability level of P<0.08.

### Results and Discussion

The first four disease ratings indicated low incidence and severity of gray mold on greenhouse tomatoes. Results of statistical analyses for the disease severity ratings, marketable and cull yield per plot are presented in Table 1. 016 resulted in a low disease severity rating (17.5%).

Yield data appeared to closely relate to the disease severity ratings (Table 1).

Ghost spot symptoms were observed on mature green fruit about mid-March and before significant foliar symptoms began to appear. Observations of fruit symptoms from the treatments suggest that no fungicide totally prevented ghost spots. Every plot had about the same amount and data was not collected on this variable. No other fruit symptoms were observed during the course of the study.

It should be noted that powdery mildew probably had an influence in this study. Ratings of powdery mildew disease severity for all treatments ranged from 22-44% leaf area affected.

TABLE 1
Botrytis disease severity ratings, marketable and cull yield of ‘Trust’
tomatoes treated with fungicides at Crystal Springs, MS, 2004.

| | Disease | Marketable | Cull Fruit |
|---|---|---|---|
| | Rating^{y} | Yield^{z} | Yield |
| Fungicide | (0-100%) | (lb/plot) | (lb/plot) |
| 016 | 17.5 b^{x} | 114.5 ab | 24.2 a |
| Control | 30.0 a | 101.2 b | 22.3 a |

^{x}Means in a column followed by the same letter are not significantly different according to Fisher's Protected Least Significant Difference Test (P = 0.08).
^{y}Plants within a row were visually rated for percentage of plant tissues affected by gray mold infection. 0 = no gray mold symptoms and 100 = whole plant showing symptoms.
^{z}Adding the weight of saleable tomatoes across all harvest dates and conducting analysis on the total weight values determined marketable yield per plot.

Pathogen: Clavibacter michiganensis subsp. michiganensis, strain E3 Tomato Variety: DRD8170 F1, greenhouse fresh market (seed hot water treated)

Treatments:

1. Water (un-inoculated)
2. 016 (2 fl oz/10 gal)
3. 016 (4 fl oz/10 gal)
4. Phyton-27 (2 fl oz/10 gal)
5. Water (inoculated)

Reps: 4

Exp. Design: Randomized Complete Block

Application Dates:
1. Jun. 12, 2002
2. Jun. 20, 2002
3. Jun. 27, 2002

Inoculation Date: Jun. 18, 2002

Inoculation Rate: 1×10⁸ cfu/ml (OD=0.3)

Rating Dates: Jul. 5, 2002

Rating Method: 96 plants from the center of each 288 cell flat were removed and 30 plants were randomly selected from the 96, 3 leaves/plant were evaluated

Rating System:

| | | |
|---|---|---|
| 0 | <5% | (Midpoint 2.5) |
| 1 | 6-20% | (Midpoint 13) |
| 2 | 21-40% | (Midpoint 30.5) |
| 3 | 41-60% | (Midpoint 50.5) |
| 4 | 61-80% | (Midpoint 70.5) |
| 5 | 81-100% | (Midpoint 90.5) |

Results:

| Treatment | Percent |
|---|---|
| (and rate) | Foliar Disease |
| Inoculated Control | 29.1 b¹ |
| 016 (2 fl oz/10 gal) | 37.9 a |
| 016 (4 fl oz/10 gal) | 17.0 d |
| Phyton-27 (2.0 fl. Oz/10 gal) | 20.8 cd |

¹Values in a column followed by the same letter are not significantly different at P ≦ 0.05.

### Field Evaluation of Materials for Control of Fire Blight Infection of Apple Blossoms Cornell University

The efficacy of a 016 was evaluated on Idared apple trees in a research orchard at Geneva, N.Y. Treatments were replicated five times with up to 200 blossom clusters per single tree replication in a randomized complete block design. Idared trees were inoculated at full bloom with Erwinia amylovora strain Ea273 at 1×10⁷ CFUml⁻¹ using a Solo back-pack sprayer. The products were applied to runoff to entire trees, at timing(s) depending on their mode of action, with a single nozzle handgun sprayer at 10.3 kg·cm⁻². Numbers of blighted and healthy blossom clusters were recorded 4 wk after inoculation. The proportion of blighted blossom clusters was determined and used as the measure of disease. The proportion of the surface of 20 fruits that became russeted was determined 6 wk after the last blossom spray. Data were analyzed by Waller-Duncan K-ratio t test using SAS.

The weather during the bloom was cooler and bloom was longer then usual, but sufficient infection took place (65.5% blossom clusters blighted [BCB] on the untreated inoculated trees) for good separation of treatments. Application of 016 resulted in significant control. Use of 016 showed no significant increase in russeting.

| | | | Timing of | % blossom | % fruit surface |
|---|---|---|---|---|---|
| (b) Materials | Rate/50 L | Surfactant/50 L | application^{z} | clusters blighted^{y} | russeted^{y} |
| None/inoculated^{x} | — | — | — | 65.5 a | 1.4 b |
| STBX-016 | 125.0 ml | Regulaid 15 ml | 3, 4 | 41.3 de | 2.1 b |

^{z}1, early pink (23 April); 2, late pink (1 May); 3, 24 hr before inoculation (7 May); 4, 24 hr after inoculation (8 May).
^{y}Mean separation by Waller-Duncan K-ratio t-test (P ≦ 0.05).
^{x}All treatments were inoculated on 7 May with Erwinia amylovora strain Ea273 at 1 × 10⁷.

### Effect of STBX-304 and Phyton 27 on Phytotoxicity on Bedding Plants

Host:

1. Salvia farinacea (blue salvia) ‘Victoria Blue’ (planted on Aug. 9, 2004)
2. Viola×wittrockiana (pansy) ‘Panola Fire’ (planted on Aug. 3, 2004)
3. Pelargonium×hortorum (geranium) ‘Goldsmith Multi-bloom White’ (planted on Jul. 15, 2004)
4. Maithiola incanae (stock) ‘Harmony Violet’ (planted on Aug. 10, 2004)

5. Catharanthus roseus (vinca) ‘Cooler Red’ (planted on Jul. 21, 2004).

| Treatments: | Rate/100 gal |
|---|---|
| A. Water | — |
| B. STBX-304 | 25 oz |
| C. STBX-304 | 45 oz |

Chemical application dates: All treatments were applied as a foliar spray (to drip) 25 Aug., 1 and 8 Sep. 2004.

On 26 Aug. 2004 phytotoxicity (flower burns) was recorded for vinca using the following scale: 1—no phytotoxicity, 2—slight, 3—moderate, 4—severe to 5—plant dead. X—no flowers.

Conclusions: Flower burns on vinca were found one day after treatment. The burns were white and slight to moderate on the 25 oz rates and moderate to severe on the 45 oz rates.

On 26 Aug. 2004 phytotoxicity (flower burns) was recorded for pansy
Conclusions: The 45 oz rate of STBX-304 had statistically higher flower burn on pansy than the remaining treatments one day after treatment.

On 26 Aug. 2004 phytotoxicity (flower burns) was recorded for Geranium because some damage was noticed, but there were very few flowers to rate and the statistics did not reflect the damage seen. There were no flowers to rate on the blue salvia and stock and no other damage found.

On 31 Aug. 2004 phytotoxicity (the number of leaves per plant with puckering) was recorded for stock.
Conclusions: There were no statistically significant differences between treatments for leaf puckering on stock. No damage was noticed on the remaining bedding plants at this rating.

On 31 Aug. 2004 residue severity was recorded for vinca
Conclusions: There were no statistically significant differences seen between treatments for residue severity on vinca. The residue present was probably due to water spotting. No residue was seen on any other bedding plants at this rating.

On 10 Sep. 2004 top grade was recorded for pansy using the following scale: 1—plant dead, unsalable, 2—poor, unsalable, 3—moderate, salable, 4—good, salable to 5—excellent, salable.
Conclusions: There were no statistical differences between treatments for top grade on pansy. On 10 Sep. 2004 top grade was recorded for geranium using the following scale: 1—plant dead, unsalable, 2—poor, unsalable, 3—moderate, salable, 4—good, salable to 5—excellent, salable. X—missing plant.

Conclusions: There were no statistical differences between treatments for top grade on geranium.

On 10 Sep. 2004 top grade was recorded for vinca using the following scale: 1—plant dead, unsalable, 2—poor, unsalable, 3—moderate, salable, 4—good, salable to 5—excellent, salable.
Conclusions: There were no significant differences between treatments for top grade on vinca at this rating.

On 10 Sep. 2004 top grade was recorded for salvia using the following scale: 1—plant dead, unsalable, 2—poor, unsalable, 3—moderate, salable, 4—good, salable to 5—excellent, salable.
Conclusions: The best top grades for salvia were found in the control. Lower quality plants were seen with STBX-304.

On 10 Sep. 2004 top grade was recorded for stock using the following scale: 1—plant dead, unsalable, 2—poor, unsalable, 3—moderate, salable, 4—good, salable to 5—excellent, salable.
Conclusions: There were no statistically significant differences between treatments for top grades on stock, but the Water—control had the best top grades at this rating.

On 10 Sep. 2004 residue severity was recorded for pansy using the following scale: 1—no residue, 2—slight, 3—moderate, 4—severe to 5—extreme, plant completely covered. X—missing plant.
Conclusions: There were no significant differences between treatments for residue severity for pansy.

On 10 Sep. 2004 residue severity was recorded for geranium using the following scale: 1—no residue, 2—slight, 3—moderate, 4—severe to 5—extreme, plant completely covered. X—missing plant.
Conclusions: There were no statistically significant differences between treatments for residue severity on geraniums at this final rating.

On 10 Sep. 2004 residue severity was recorded for vinca using the following scale: 1—no residue, 2—slight, 3—moderate, 4—severe to 5—extreme, plant completely covered.
Conclusions: There were no statistically significant differences between treatments for residue severity on vinca at this final rating.

On 10 Sep. 2004 residue severity was recorded for blue salvia using the following scale: 1—no residue, 2—slight, 3—moderate, 4—severe to 5—extreme, plant completely covered.
Conclusions: There was significant but very slight residue found on the blue salvia for the 25 oz rate of STBX-304 in the slight to moderate range. All treatments including the Water—control had very slight levels of residue.

On 10 Sep. 2004 residue severity was recorded for stock using the following scale: 1—no residue, 2—slight, 3—moderate, 4—severe to 5—extreme, plant completely covered.
Conclusions: There were no statistically significant differences between treatments for residue severity on stock at this date.

Summary for the effect of STBX-304 on phytotoxicity on bedding plants

| | | Phytotoxicity | Phytotoxicity | Phytotoxicit | Top Grade | Top Grade |
|---|---|---|---|---|---|---|
| | | 26 August | 26 August | 31 August | 10 September | 10 September |
| Treatment | Rate/100 gal | Vinca | Pansy | Stock | Pansy | Geranium |
| Water - | — | 1.2 a | 1.1 a | 4.2 a | 2.7 a | 3.5 a |
| Control | | | | | | |
| STBX-304 | 25 oz | 3.2 bc | 1.1 a | 4.3 a | 2.5 a | 3.3 a |
| STBX-304 | 45 oz | 3.5 c | 1.5 b | 5.5 a | 2.9 a | 3.2 a |

Summary for the effect of STBX-304 on phytotoxicity on bedding plants

| | | Top Grade | Top Grade | Top Grade | Residue | Residue |
|---|---|---|---|---|---|---|
| | | 10 September | 10 September | 10 September | 31 August | 10 September |
| Treatment | Rate/100 gal | Vinca | Blue Salvia | Stock | Vinca | Pansy |
| Water - | — | 4.5 a | 4.0 b | 3.0 a | 2.0 a | 1.5 a |
| Control | | | | | | |
| STBX-304 | 25 oz | 4.3 a | 3.7 ab | 2.8 a | 2.2 a | 1.4 a |
| STBX-304 | 45 oz | 4.0 a | 3.6 ab | 2.7 a | 2.1 a | 1.7 a |

| | | Residue | Residue | Residue | Residue |
|---|---|---|---|---|---|
| | | 10 September | 10 September | 10 September | 10 September |
| Treatment | Rate/100 gal | Geranium | Vinca | Blue Salvia | Stock |
| Water - | — | 1.8 a | 2.0 a | 1.1 ab | 2.0 a |
| Control | | | | | |
| STBX-304 | 25 oz | 1.8 a | 2.2 a | 1.4 b | 2.0 a |
| STBX-304 | 45 oz | 1.9 a | 2.0 | 1.1 ab | 2.1 a |

### Pesticide Efficacy Trials for Ornamental Plant Diseases—2004 University of Florida

### Control of Erwinia on Phalaenopsis Orchid

Materials & Methods:

| Treatments | | |
|---|---|---|
| Trt # | Product | Application (7day cycle, 2 trt.) |
| 1 | Water control | — |
| 2 | Disease control | — |
| 3 | STBX-304 | 2.5 fl oz/10 gal |
| 4 | STBX-304 | 3.5 fl oz/10 gal |

Plants Utilized. Phalaenopsis orchid (‘Jupiter’) were established in 5″ pots containing sphagnum moss. The experiment was set-up in randomized block design with 9 plants per treatment.

Inoculum Production. A culture of Erwinia chrysanthemi was harvested from NA plates, and adjusted at A₆₀₀ to 1×10⁷ colony forming units/mL. One pinpricks was made on three separate leaves. Plants were sprayed till run-off with the bacterial suspension and enclosed in clear polyethylene bag for 24 h. Number of lesions per treatment were compared using ANOVA and LSD procedures.

One-bactericide pretreatment (May 28, 2004) was done four days before bacteria were applied (Jun. 1, 2004). A second bactericide application was done 7 days after the first (Jun. 4, 2004). Evaluations were done seven days after second bactericide application (Jun. 11, 2004).

Results:

All treatments helped in lowering damage caused by Erwinia.

STBX-304 Phytotoxicity Test Results

| SCIENTIFIC NAME | | |
|---|---|---|
| OBSERVED | COMMON NAME | PHYTOTOXICITY |
| Eriobotryia japonica | Loquat | None |
| Eugenia sp. | Eugenia | None |
| Euphorbia milii | Crown of Thorns | None |
| Evolvulus glomerata | Blue Daze | None |
| Ficus benjamina | Weeping fig | None |
| Ficus Macclellandii Alii | Ficus | None |
| Ficus Retusa | Cuban Laurel | None |
| Galphimia gracillis | Thryallis | None |
| Gardenia jasminoides | Gardenia | None |
| Grewia caffra | Lavendar starflower | None |
| Guzmania meyendorfii | Bromeliad | None |
| Hedera helix | English ivy | None |
| Heliconia lattifolia | Heliconia | None |
| Hibiscus rosa sinensis | Hibiscus | None |
| Hibiscus snow Queen | Snow Queen hibiscus | None |
| Hosta sp. | Hosta | Possible leaf burn |
| Ilex schillings | Holly | None |
| Ipomoea batatas | Sweet potato vine | None |
| Ixora maui | Maui Ixora | None |
| Ixora | Nora Grant Ixora | None |
| Impatiens wallerana | Impatiens | None |
| Jasmine gracillimum | Pinwheel jasmine | None |
| Jasmine simplicifolia | Jasmine simp | None |
| Jatropha multifida | Coral plant | None |
| Kalanchoe sp. | Kalanchoe | None |
| Lagerstroemia indica | Crepe Myrtle | None |
| Lantana sp. | Lantana | None |
| Lantana variegate | Variegated Lantana | None |
| Leea coccinia rubrum | Red leea | None |
| Ligustrum recurvifolia | Privet | None |
| Liriope muscari | Evergreen giant | None |
| Malpighia sp. | Dwarf barbados cherry | None |
| Manilkara roxburghiana | Mimusops | None |
| Mesembryanthemum sp | Ice plant | None |
| Musa acuminata | Cavendish banana | None |
| Myrcianthus fragrans | Simpson stopper | |
| Nephrolepis exaltata | Boston fern | None |
| Nephrolepis falcate | Fishtail fern | None |
| Nerium oleander | Oleander | None |
| Ophiopogon japonicus | Mondo grass | None |
| Ophiopogon sp | Aztec grass | None |
| Pachira sp. | Shaving brush tree | None |
| Pachystachus coccinea | Cardinal's guard | None |
| Pachystachus lutea | Golden shrimp plant | None |
| Pennisetum setaceum | Red fountain grass | None |
| Phaius tankervilliae | Nun's orchid | None |
| Philodendron sp. | Philodendron | None |
| | Imperial green | |
| Phoenix Roebellinii | Pygmy date palm | None |
| Pilea microphylla | Artillery fern | None |
| Pittosporum tobira | Mock orange | None |
| Pittosporum tobira | Variegated Pittosporum | None |
| variegata | | |
| Polyscias fruticosa | Parsley aralia | None |
| Plumbago | Plumbago | None |
| Plumeria alba | Franjipani | None |
| Podocarpus macrophylla | Yew | None |
| Portulaca oleracea | Purslane | None |
| Ptychosperma | Macarthur palm | None |
| macarthurii | | |
| Raphiolepis indica | India hawthorne | None |
| Rhapis excelsa | Lady palm | |
| Rosa hybrida | Rose | None |
| Ruellia brittoniana | Mexican bluebell | None |
| Salvia splendens | Salvia | None |
| Sanchezia speciosa | Sanchezia | None |
| Sansevieria laurentii | Mother in law's tongue | None |
| Sansevieria zeylanica | Snake plant | None |
| Schefflera arboricola | Dwarf schefflera | None |
| Schefflera Gold Capella | Variegated schefflera | None |
| Sedum album | Sedum | None |
| Setcreasea pallida | Purple Queen | None |
| Spathiphyllum | Mauna Loa Peace lily | None |
| Strelitzia nicolai | White Bird of Paradise | None |
| Strelitzia reginae | Bird of Paradise | None |
| Syagrus romanzoffianum | Queen palm | None |
| Syngonium podophyllum | White butterfly | |
| Tabebuia pallida | Pink tabebuia | None |
| Thunbergia sp. | Thunbergia | None |
| Tibouchina grandiflora | Purple glory tree | None |
| Tibouchina urvilleana | Glory bush | None |
| Torenia | Torenia | None |
| Trachelospermum | Confederate jasmine | None |
| Jasminoides | | |
| Tradeschantia sp. | Wandering Jew | None |
| Viburnum odoratissimum | Akabuki Awabuki | None |
| | viburnum | |
| Viburnum suspensum | Sweet viburnum | None |
| Wodyetia bifurcata | Foxtail palm | None |
| Zamia furfuraceae | Coontie | |

### Evaluation of Products for Control of Bacterial Spot on Peach Using 016 University of Georgia

Start Date: 14 Apr. 2005

Completion Date: July 2005

Methodology

The test was established in a mature O'Henry peach orchard in Ft. Valley, Ga. Routine, early season copper sprays were omitted to allow build-up of inoculum for the test. Single-tree plots, replicated four times, were surrounded by untreated buffer trees. Starting at shuck split and using a handgun sprayer, treatments (Table 1) were applied in a water volume of about one gallon (equivalent of about 100 gallons per acre) per tree at 7 to 13-day intervals.

The incidence of infected fruit (percent fruit with bacterial spot symptoms) was determined separately for all symptomatic fruit (regardless of severity) and for those showing severe symptoms (deep-pitted lesions). Assessments were made during the green fruit stage and prior to harvest (late July/early August) on a sample of 60 fruit per tree.

Results

Phytotoxicity symptoms on leaves were noted in the STBX-016 treated plots after two and five consecutive applications, respectively. Phytotoxicity symptom severity (i.e., percent leaf area affected) was low, symptoms did not increase over time, and were not associated with any increase in defoliation. At the rates applied, STBX-016 was not considered to pose a significant phytotoxicity risk.

Bacterial spot pressure was extremely high, due to favorable weather. During green fruit assessment in late June, fruit disease incidence was reduced significantly in STBX-016 treated trees, while none of the other treatments resulted in significant disease control. By late July, all plots showed very high levels of disease incidence and there were no significant reductions in disease compared with the untreated check.

### CONCLUSIONS

Only STBX-016 and oxytetracycline (the standard) provided statistically significant disease reductions compared with the untreated check. While STBX-016 caused some phytotoxicity on leaves, symptoms did not increase over time, nor were they associated with increased levels of defoliation.

| | | | Late June - | | Late July - | |
|---|---|---|---|---|---|---|
| | | | Green Fruit | | Mature Fruit | |
| | Rate/ | | % symp- | % deep- | % | % deep- |
| | 100 | | tomatic | pitted | symptomatic | pitted |
| Trt | gal | Phytotox¹ | fruit | lesions | fruit | lesions |
| Control | — | 57.80 a | 83.91 a | 45.46 a | 94.35 a | 75.89 a |
| STBX- | 9 oz | 70.56 a | 68.75 b | 30.42 a | 86.99 a | 60.64 a |
| 016 | | | | | | |

¹Defoliation rated as number of leaves per m² of ground
Means followed by the same letter are not significantly different per Tukey grouping, where P = 0.05.

### Evaluation of STBX-016 for Control of Bacterial Spot on Bell Pepper and Tomato

### Plot Trials, Zellwood, Fla.

Start Date: February 2005

Completion Date: July 2005

Methodology

Test plots were established in Zellwood, Fla. in the spring of 2005 to evaluate STBX-016 at 20 ounces per acre. Bacterial spot control was rated using a visual scale of 0-100, where 0=no disease and 100=dead plants.

Capistrano peppers were transplanted on 2 Mar. 2005 and were inoculated on 27 April and 18 May with a laboratory cultured Xanthomonas campestris pv. vesicatoria spore suspension. STBX-016 was applied using a CO₂ powered backpack sprayer for seven applications at 6 to 14-day intervals.
Agriset tomatoes were transplanted on 28 Feb. 2005 and were inoculated on 20 and 27 of April and 18 of May. STBX-016 was applied using a CO2 powered backpack sprayer for six applications at 7 to 14-day intervals.
   Results:

STBX-016 significantly reduced bacterial spot on bell pepper and tomato compared to the untreated control. Data were analyzed using Duncan's MRT at the 0.10 level of significance. Values within each column followed by the same letters are not significantly different.

TABLE 1
Control of Bacterial Spot on Bell Pepper

| Trtmts | 5/27 | 6/2 | 6/9 | 6/17 | Avg |
|---|---|---|---|---|---|
| STBX-016 | 15 a | 17.5 ab | 15 b | 27.5 a | 18.8 b |
| UTC | 17.5 a | 25 a | 27.5 a | 32.5 a | 25.6 a |

TABLE 2
Control of Bacterial Spot on Tomato

| | | | | Avg 3 | | Avg 4 |
|---|---|---|---|---|---|---|
| Trtmts | 5/27 | 6/2 | 6/9 | ratings | 6/17 | ratings |
| STBX-016 | 17.5 bc | 40 b | 57.5 b | 38.3 bc | 72.5 ab | 37.5 bc |
| UTC | 32.5 a | 57.5 a | 75 a | 55 a | 95 a | 52 a |

### Evaluation of Phyton-016-B for the Control of Powdery Mildew on Miniature Rose

### Chase Research Gardens, Mt Aukum, Calif.

Start Date: September 2005

Completion Date: October 2005

Methodology

The trial was conducted on miniature rose, varieties ‘Sonja’, ‘Mistral’ and ‘Denise’. Plants were naturally infected at the beginning of the trial. All treatments were applied as foliar sprays to drip, at 7-day intervals, on 15 and 26 Sep. 2005. Disease control was evaluated by estimating the percentage of leaf area with powdery mildew sporulation (9 plants per treatment).
   Results

Phyton-016-B stopped new disease from starting and slightly reduced pre-existing powdery mildew.

Control of Powdery Mildew on Miniature Rose

| | | % leaf area with |
|---|---|---|
| | | sporulation |
| Treatment | Rate/100 gal | 28 September |
| Water | — | 84.4 b |
| Phyton-016-B | 25 oz | 58.3 a |

### Evaluation of Products for the control of Powdery Mildew on Hydrangea Using STBX-304

### Cornell University—Riverhead, N.Y.

Start Date: March 2005

Completion Date: April 2005

Methodology

Potted hydrangea, cultivar ‘Blau Doneau’ with a pre-existing low level of powdery mildew were used for this trial. Plants were arranged in 11 single plant replications in a randomized complete block design. Treatments were applied to drip using a hand-held CO₂ sprayer at 30 psi, for 5 applications at 7-day intervals.

Results

All treatments effectively curbed the powdery mildew epidemic. No phytotoxicity was observed on foliage or flowers.

| Trt | Rate | | 4/12 | 4/19 | 4/26 |
|---|---|---|---|---|---|
| Control | — | 3.6 | 5.5 b | 10.4 b | 15.3 b |
| STBX-304 | 1.5 oz/10 gal | 1.3 | 1.6 a | 2.6 a | 2.4 a |
| STBX-304 | 2.5 oz/10 gal | 1.7 | 1.7 a | 2.1 a | 2.5 a |

Values represent means of 11 replications of a single plant.
Values followed by the same letter are not significantly different (Fisher's Protected LSD, P = 0.05)

### Dosage Response, In Vitro, of Six Fungi to STBX-304

### Chase Research Gardens, Mt Aukum, Calif.

Methodology

Potato dextrose agar was prepared, sterilized and allowed to cool to “pouring temperature” before amendment with STBX-304 at 0.5, 1.0 and 2.0 ml per 500 ml medium. Plates were poured and stored in the dark for 1-2 days prior to use. Plates were inoculated by placing a 3×3 mm disk of the fungus in the center of the plate. The inoculated plates were incubated at room temperature for 4-6 days. Pathogens included in this trial were Botrytis cinerea, Alternaria alternate, Fusarium oxysporum fsp. cyclamensis, Rhizoctonia solani, Thielaviopsis basicola, and Cylindrocladium pauciramosum. Colony diameter was measured to evaluate fungal response.

Results

STBX-304 significantly reduced fungal growth of all six fungal pathogens, as measured by mean colony diameter, as compared to the untreated control.

In Vitro Control of Six Fungi

| Trt & rate/ | Mean Colony Diameter | | | | | |
|---|---|---|---|---|---|---|
| 500 ml | Botrytis | Rhizoctonia | Fusarium | Alternaria | Thielaviopsis | Cylindrocladium |
| Control | 48.6 e | 82.2 g | 44.2 g | 32.7 e | 24.2 d | 30.2 d |
| STBX-304 | 25.4 cd | 50.8 e | 25.0 d | 25.8 d | 16.0 c | 20.6 c |
| 0.5 ml | | | | | | |
| STBX-304 | 21.2 b | 25.2 bc | 16.6 bc | 16.6 b | 5.6 a | 20.2 c |
| 1.0 ml | | | | | | |
| STBX-304 | 11.2 a | 20.8 ab | 14.8 b | 12.8 a | 4.6 a | 15.6 b |
| 2.0 ml | | | | | | |

### Evaluation of STBX-304 for Control of Bacterial Blight of Lilac

### Oregon State University, Corvalis, Oreg.

Start Date: February 2005

Completion Date; May 2005

Methodology

Treatments were arranged in a randomized complete block design in a block of ‘Ellen Willmott’ lilacs. Each treatment consisted of 4 single shrub replicates. Non-treated bushes were on either side of treated bushes. All bactericides were applied using a pump-style backpack sprayer at a rate of 50 gallons water per acre. Treatments were applied on 14 Feb. 2005 (buds swollen), 1 Mar. 2005 (early shoot growth), 15 Mar. 2005 (leaves out) and 30 Mar. 2005 (early bloom). Incidence of bacterial blight was evaluated on 11 and 28 April by examining 100 arbitrarily selected shoots per bush.

Results

STBX-304 significantly decreased bacterial blight (% shoots blighted) at the 11 April rating. Bacterial blight was reduced numerically, but not significantly, at the final rating. No phytotoxicity was observed with treatment.

Bacterial Blight
(% shoots)

| Treatment and rate | 11 Apr | 28 Apr |
|---|---|---|
| Nontreated | 37.8 a | 24.5 a |
| STBX-304 at 0.25 fl oz/gal | 20.3 b | 13.0 ab |

Means followed by the same letter do not differ significantly based on Fisher's protected LSD (P = 0.05)

### Evaluation of STBX-304 for Control of Black Spot Roses

### Auburn University Ornamental HRC, Mobile, Ala.

Start Date: February 2005

Completion Date: October 2005

Methodology

Rose liners, variety Freedom Red, were potted in one gallon containers. The experimental design was a randomize complete block with six single plant replications. Fungicides were applied to drip at 2-week intervals from 17 February until 26 September with a CO₂-pressurized sprayer at 40 psi. Black spot incidence was visually rated on 23 August and 26 September where 1=no disease, 2=0 to 3%, 3=3 to 6%, 4=6 to 12%, 5=12 to 25%, 6=25 to 50%, 7=50 to 75%, 8=75 to 87%, 9=87 to 94%, 10=94 to 97%, 11=97 to 100%, and 12=100% of the leave damaged or prematurely shed due to black spot.

Results

Clusters of small tan spots were found along the edge of the roses treated with STBX-304. STBX-304 applied at 25 fluid ounces per 100 gallons water significantly reduced black spot on roses as compared to the untreated control.

Control of Black Spot on Roses

| | Disease Incidence | | |
|---|---|---|---|
| Fungicide & Rate/100 gal | 23 Aug | 8 Sep | 26 Sep |
| STBX-304 25 fl oz | 2.0 ab | 6.3 a | 4.3 cd |
| STBX-304 40 fl oz | 2.0 ab | 6.3 a | 5.8 abc |
| Untreated Control | 2.0 ab | 6.8 a | 7.3 a |

Means followed by the same letter are not significantly different according to Fisher's protected lest significant difference test (P=0.05).

### Evaluation of STBX-304 for Control of Downy Mildew on Limonium

### University of California, Riverside—San Luis Rey, Calif.

Start Date: March 2005

Completion Date: May 2005

Methodology

Plants of Limonium cultivar ‘Misty Blue’ were trimmed in March 2005 and new vegetative growth was used for the trial. STBX-304 was applied as a foliar spray, with a CO₂-powered sprayer at 40 psi, for four applications at 7 to 10-day intervals. Plants were visually evaluated for disease severity (whole plot rating) on 29 Apr. 2005 and 6 May 2005 and for phytotoxicity on 6 May 2005.

Results

STBX-304 significantly reduced disease severity as compared to the non-treated check. There was some minor, but statistically significant, phytotoxicity, observed as spots on the foliage.

Control of Downy Mildew on Limonium

| | | | Disease | Disease | |
|---|---|---|---|---|---|
| Treatments | | | Severity | Severity | Phytotoxicity |
| Product | Rate/gallon | Rate/liter | 29 April | 6 May | 6 May |
| Non-Treated | — | — | 2.38 a | 3.25 a | 0.00 c |
| Check | | | | | |
| STBX-304 | 0.15 fl oz | 1.2 ml | 1.50 b | 2.13 b | 0.43 b |
| STBX-304 | 0.25 fl oz | 1.9 ml | 1.38 b | 1.38 b | 0.65 a |

Means followed by the same letter within columns are not significantly different according to the least significant difference (LSD) test at P=0.05
Experimental Design: randomized complete block, 4 replications per treatment
Disease Evaluation: visual rating of disease severity on a 0-5 scale (0=no disease)
Phytotoxicity Evaluation: visual rating of phytotoxicity on a 0-5 scale (0=no phytotoxicity)

### Evaluation of STBX-304 for the Control of Powdery Mildew on Gerbera

### Chase Research Gardens, Mt Aukum, Calif.

Start Date: October 2004

Completion Date: November 2004

Methodology

The trial was conducted on Gerbera Daisy, varieties ‘Royal Deep Orange Dark’. Plants were inoculated by natural infection by placing infected plants randomly into the test blocks. All treatments were applied as foliar sprays to drip, at 10-day intervals, on 15 and 26 Oct. and 4 Nov. 2004. Disease control was evaluated by counting the number of powdery mildew colonies per plant (12 plants per treatment). Phytotoxicity was evaluated using a 1 to 5 scale where 1=none, 2=slight (leaf burn), 3=moderate, 4=severe to 5=plant dead.

Results

Both rates of STBX-304 were safe, no phytotoxicity, when applied to gerbera daisy. Both rates did an excellent job controlling powdery mildew, with complete control.

Control of Powdery Mildew on Gerbera

| | | | # mildew colonies |
|---|---|---|---|
| | | Phytotoxicity | per plant |
| Treatment | Rate/100 gal | 1 November | 8 November |
| Water | — | 1.0 a | 40.4 b |
| STBX-304 | 25 oz | 1.0 a | 0 a |
| STBX-304 | 45 oz | 1.0 a | 0 a |

### Evaluation of STBX-304 for the Control of Powdery Mildew on Roses

### Virginia Tech, Virginia Beach, Va.

Start Date: April 2005

Completion Date: May 2005

Methodology

A miniature rose cultivar ‘Heartbreaker’ was used for the trial. Fungicide treatments were applied to runoff with a CO₂-pressurized sprayer at 35 psi. Treatments were arranged in a randomized complete block design. The first treatment was made on 12 Apr. 2005 with five subsequent treatments at weekly intervals until 17 May 2005. Test plants were evaluated every 2 weeks, 19 April through 17 May. Powdery mildew was evaluated based on symptoms of necrosis with whitish mycelium on leaf surface, using a 1 to 12 scale:

1=no disease

2=0 to 3% of leaves diseased

3=3 to 6% of leaves diseased

4=6 to 12% of leaves diseased

5=12 to 25% of leaves diseased

6=25 to 50% of leaves diseased

7=50 to 75% of leaves diseased

8=75 to 87% of leaves diseased

9=87 to 94% of leaves diseased

10=94 to 97% of leaves diseased

11=97 to 100% of leaves diseased

12=100% of leaves diseased or prematurely shed

Results

STBX-304 significantly reduced powdery mildew severity on rose in this trial. There were extensive phytotoxicity symptoms at the first two assessments, which decreased with time.

Control of Powdery Mildew on ‘Heartbreaker’
mini-roses in a greenhouse

| | | Powdery Mildew | | |
|---|---|---|---|---|
| Treatment | Rate | 4/19 | 5/3 | 5/17 |
| Water | — | 25.7 a | 20.5 a | 15.3 a |
| STBX-304 | 25 fl oz/100 gal | 18.1 a | 13.9 ab | 8.7 b |
| STBX-304 | 40 fl oz/100 gal | 25.3 a | 112.8 ab | 8.7 b |

Means followed by the same letter did not differ significantly according to LSD test at P=0.05.

It is apparent that many modifications and variations of this invention as hereinbefore set forth may be made without departing from the spirit and scope thereof. The specific embodiments described are given by way of example only.

What is claimed is:

1. A chemotherapeutic agent comprising a tannate complex of cupric ammonium formate in an aqueous solution wherein for each 100 parts by dry weight of ammonium formate said complex includes about 1 to 10 parts by weight of tannic acid combined with about 0.05 to about 230 parts by weight of a cupric salt and with surfactant sufficient to prevent precipitation of the tannate complex.

2. The agent of claim 1 wherein said cupric salt is copper sulfate pentahydrate.

3. The agent of claim 1 wherein said surfactant comprises sodium lauryl sulfate and decyl glucoside

4. The agent of claim 1 wherein said surfactant is an alkali metal alkyl sulphate.

5. The agent of claim 4 wherein said surfactant is sodium lauryl sulphate.

6. The agent of claim 1 wherein said surfactant is sodium docecylbenzenesulfonate.

7. A process for the control of plant diseases caused by viral, bacterial and fungal organisms which comprises treating diseased plants with an effective amount of an agent according to claim 1.

8. A process for the preparation of the agent of claim 1 which comprises reacting about 0.01 and 45 parts by weight of a water-soluble cupric salt with about 2 to 18 parts by weight of ammonium formate in about 10 to 90 parts by weight of water in which about 0.2 to about 2 parts by weight of tannic acid is dissolved.

9. The process of claim 8 including adding surfactant is added in amount between 2 to 24 parts by weight.

10. The process of claim 9 wherein said surfactants comprise sodium lauryl sulfate in about 1 to about 10 parts and sodicum docecylbenzensulfonate in about 1 to about 14 parts by weight.

11. The process of claim 9 wherein said surfactants comprise sodium lauryl sulfate in about 4 parts by weight and decyl glucoside in about 13 parts by weight.
